(19) United States
(12) Patent Application Publication
(10) Pub. No.: US 2026/0139100 A1
(43) Pub. Date: May 21, 2026

(54) RESIN COMPOSITION CONTAINING SILICONE-VINYL ACETATE COPOLYMER RESIN, AND METHOD FOR PRODUCING SAME

(71) Applicant: Nissin Chemical Industry Co., Ltd., Echizen-shi, Fukui (JP)

(72) Inventor: Koki Uchida, Echizen-shi (JP)

(73) Assignee: Nissin Chemical Industry Co., Ltd., Echizen-shi, Fukui (JP)

(21) Appl. No.: 19/118,525

(22) PCT Filed: Sep. 27, 2023
(86) PCT No.: PCT/JP2023/035062

§ 371 Date: Apr. 4, 2025

(30) Foreign Application Priority Data
Oct. 14, 2022 (JP) 2022-165231

(51) Int. Cl. C08G 77/442

(52) U.S. Cl. CPC C08G 77/442

(57) ABSTRACT

The present invention provides a resin composition containing (C) a water-soluble polymer and a copolymer resin of (A) an organopolysiloxane unit derived from an organopolysiloxane represented by a specific general formula and (B) a vinyl acetate unit, wherein the resin composition containing a silicone-vinyl acetate copolymer resin is characterized in that the mass ratio of the (A) organopolysiloxane units and the (B) vinyl acetate units is (A):(B)=10:90-95:5, and the mass ratio of the (B) vinyl acetate units and the (C) water-soluble polymer is 100:5-50. The resin composition of the present invention has slidability, base material adhesiveness, and organic solvent solubility and can be used suitably in coating agents for various base materials, adhesives, interior and exterior paints for structures, building materials, etc., cosmetics, etc.

### TECHNICAL FIELD

This invention relates to a resin composition comprising a resin obtained from copolymerization of an organopolysiloxane with vinyl acetate and a method for preparing the same, and more particularly, to a silicone-vinyl acetate copolymer resin having slidability, substrate adhesion, solvent resistance and scratch resistance and a method for preparing the same.

### BACKGROUND ART

From the past, silicone resins are known as resins capable of imparting slidability to substrates. When silicone resins are used alone, however, there arise some problems like poor adhesion to substrates.

It is thus a common practice to copolymerize silicone resins with other monomers such as acrylic and urethane monomers. For example, copolymers such as acrylic silicone copolymers and urethane silicone copolymers are able to provide ordinary acrylic and urethane base emulsions with the weather resistance, heat resistance, freeze resistance, water repellency, gas permeability, and slidability of silicone resins. For example, Patent Document 1 (JP-A 2020-90563) discloses a silicone acrylic graft copolymer resin capable of imparting slidability and a method of preparing the same.

On the other hand, vinyl acetate resins are heretofore used as emulsion type adhesives, screen printing photosensitive materials, laundry starch, chewing gum bases, emulsifiers, and cosmetic bases. They are known as fully adhesive resins.

Exemplary vinyl acetate resins having other monomers copolymerized therewith include vinyl acetate resins having ethylene copolymerized therewith, i.e., ethylene-vinyl acetate copolymers. These copolymers are synthetic resins possessing adhesiveness and flexibility ascribed to vinyl acetate units. They are used as coating agents for food wrapping paper and paper containers such as paper cups, adhesives for fabric and paper labels, emulsion type adhesives, chewing gum bases, artificial turf, sandal soles, bath mats, bathroom boots, kickboards, jumping ropes, and the like.

Although silicone resins and vinyl acetate resins possess contradictory properties, the inventor succeeded in developing silicone-vinyl acetate copolymer resins possessing the properties of both silicone resins and vinyl acetate resins as disclosed in JP-A 2022-131528.

Silicone-vinyl acetate copolymer resins, however, have the drawbacks of poor solvent resistance and scratch resistance. There is left room for improvement.

### PRIOR ART DOCUMENTS

### Patent Documents

Patent Document 1: JP-A 2020-090563
Patent Document 2: JP-A 2022-131528

### SUMMARY OF INVENTION

### Technical Problem

An object of the invention, which has been made under the above-mentioned circumstances, is to provide a resin composition comprising a silicone-vinyl acetate copolymer resin having slidability, substrate adhesion, solvent resistance and scratch resistance, and a method for preparing the same.

### Solution to Problem

Making extensive investigations to attain the above object, the inventor has found that a resin composition comprising a copolymer resin consisting of (A) organopolysiloxane units and (B) vinyl acetate units, and (C) a water-soluble polymer has slidability, substrate adhesion, solvent resistance and scratch resistance. The invention is predicated on this finding.

Accordingly, the invention provides a resin composition comprising a silicone-vinyl acetate copolymer resin, a method for preparing the same, and a dispersion, as defined below.

1. A resin composition comprising a copolymer resin consisting of (A) organopolysiloxane units derived from an organopolysiloxane having the general formula (1) and (B) vinyl acetate units, and (C) a water-soluble polymer, wherein the weight ratio of organopolysiloxane units (A) to vinyl acetate units (B), i.e., (A):(B) is from 10:90 to 95:5, and the weight ratio of vinyl acetate units (B) to water-soluble polymer (C) is from 100:5 to 100:50,

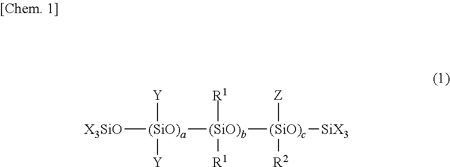

wherein R¹ which may be the same or different is a substituted or unsubstituted C₁-C₂₀ monovalent hydrocarbon group, R² is a mercapto, acryloxy or methacryloxy-substituted C₁-C₆ alkyl group or vinyl group, X which may be the same or different is a substituted or unsubstituted C₁-C₂₀ monovalent hydrocarbon group, C₁-C₂₀ alkoxy group or hydroxy group, Y which may be the same or different is X or —[O—Si(X)₂]_{d}—X, at least two of X and Y are hydroxy, Z is a C₁-C₄ alkyl group, C₁-C₄ alkoxy group or hydroxy group, a is a positive number of 0 to 1,000, b is a positive number of 100 to 10,000, c is a positive number of 1 to 10, and d is a positive number of 1 to 1,000.
2. The resin composition of 1 described above which is in the form of an emulsion having a viscosity at 25° C. of 1 to 500 mPa·s.
3. The resin composition of 1 or 2 described above wherein the organopolysiloxane having formula (1) has a weight average molecular weight (Mw) based on viscosity measurement of 10,000 to 1,000,000.
4. The resin composition of 1 or 2 described above wherein the organopolysiloxane having formula (1) is a polymer of a cyclic organosiloxane, α,ω-dihydroxysiloxane oligomer, α,ω-dialkoxysiloxane oligomer or alkoxysilane with a silane coupling agent having the general formula (2):

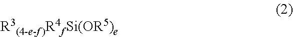

wherein R³ is a mercapto, acryloxy or methacryloxy-substituted C₁-C₆ alkyl group, R⁴ is a C₁-C₄ alkyl group, R⁵ is a C₁-C₄ alkyl group, e is 2 or 3, f is 0 or 1, and e+f is 2 or 3.
5. The resin composition of 1 or 2 described above which is used as a product selected from coating agents, textile treating agents, adhesives, paints and cosmetics.
6. A dispersion comprising the resin composition of 1 or 2 described above.
7. A method for preparing a resin composition comprising the steps of emulsion polymerizing (A-1) an organopolysiloxane having the general formula (1) with (B-1) vinyl acetate in a weight ratio (A-1):(B-1) of from 10:90 to 95:5, and admitting (C) a water-soluble polymer during the emulsion polymerization, in an amount of 5 to 50 parts by weight of water-soluble polymer (C) as solids per 100 parts by weight of vinyl acetate (B-1), thereby forming a resin emulsion,

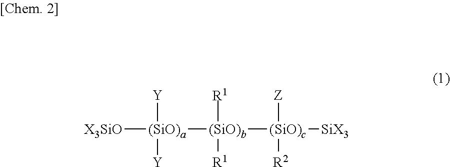

wherein R¹ which may be the same or different is a substituted or unsubstituted C₁-C₂₀ monovalent hydrocarbon group, R² is a mercapto, acryloxy or methacryloxy-substituted C₁-C₆ alkyl group or vinyl group, X which may be the same or different is a substituted or unsubstituted C₁-C₂₀ monovalent hydrocarbon group, C₁-C₂₀ alkoxy group or hydroxy group, Y which may be the same or different is X or —[O—Si(X)₂]_{d}—X, at least two of X and Y are hydroxy, Z is a C₁-C₄ alkyl group, C₁-C₄ alkoxy group or hydroxy group, a is a positive number of 0 to 1,000, b is a positive number of 100 to 10,000, c is a positive number of 1 to 10, and d is a positive number of 1 to 1,000.

### Advantageous Effects of Invention

The resin composition comprising a silicone-vinyl acetate copolymer resin possesses slidability, substrate adhesion, solvent resistance and scratch resistance. The resin composition is thus advantageously used as coating agents on various substrates, adhesives, internal and external paints for structures and building materials, and cosmetics.

### DESCRIPTION OF EMBODIMENTS

One embodiment of the invention is a resin composition comprising a copolymer resin consisting of (A) organopolysiloxane units and (B) vinyl acetate units, and (C) a water-soluble polymer.

The organopolysiloxane units (A) are derived from an organopolysiloxane having the general formula (1).

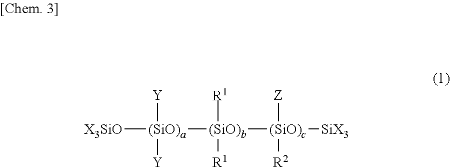

Herein R¹ which may be the same or different is a substituted or unsubstituted C₁-C₂₀ monovalent hydrocarbon group, R² is a mercapto, acryloxy or methacryloxy-substituted C₁-C₆ alkyl group or vinyl group, X which may be the same or different is a substituted or unsubstituted C₁-C₂₀ monovalent hydrocarbon group, C₁-C₂₀ alkoxy group or hydroxy group, Y which may be the same or different is X or —[O—Si(X)₂]_{d}—X, at least two of X and Y are hydroxy, Z is a C₁-C₄ alkyl group, C₁-C₄ alkoxy group or hydroxy group, a is a positive number of 0 to 1,000, b is a positive number of 100 to 10,000, c is a positive number of 1 to 10, and d is a positive number of 1 to 1,000.

R¹ which may be the same or different is a substituted or unsubstituted C₁-C₂₀ monovalent hydrocarbon group. Examples thereof include alkyl groups such as methyl, ethyl, propyl, butyl, pentyl, hexyl, heptyl, octyl, nonyl, decyl, dodecyl, tetradecyl, hexadecyl, and octadecyl; cycloalkyl groups such as cyclopentyl, cyclohexyl and cycloheptyl; alkenyl groups such as vinyl and allyl, aryl groups such as phenyl, tolyl and naphthyl, alkenylaryl groups such as vinylphenyl, aralkyl groups such as benzyl, phenylethyl and phenylpropyl, alkenylaralkyl groups such as vinylbenzyl and vinylphenylpropyl, and substituted forms of the foregoing groups in which some or all of the hydrogen atoms are substituted by halogen such as fluorine, bromine and chlorine, acryloxy, methacryloxy, carboxy, alkoxy, alkenyloxy, amino, or alkyl, alkoxy or (meth)acryloxy-substituted amino groups. R¹ is preferably methyl.

R² is a mercapto, acryloxy or methacryloxy-substituted C₁-C₆ alkyl group or vinyl group. Specifically, mercaptopropyl, acryloxypropyl, methacryloxypropyl, and vinyl are preferred.

X which may be the same or different is a substituted or unsubstituted C₁-C₂₀ monovalent hydrocarbon group, C₁-C₂₀ alkoxy group or hydroxy group. Examples of the substituted or unsubstituted C₁-C₂₀ monovalent hydrocarbon group are as exemplified above for R¹. Examples of the C₁-C₂₀ alkoxy group include methoxy, ethoxy, propoxy, butoxy, hexyloxy, heptyloxy, octyloxy, decyloxy, and tetradecyloxy. X is preferably hydroxy, methyl, butyl or phenyl.

Y which may be the same or different is X or —[O—Si(X)₂]_{d}—X.

Z is a C₁-C₄ alkyl group, C₁-C₄ alkoxy group or hydroxy group, preferably hydroxy or methyl.

The subscript “a” is a positive number of 0 to 1,000, preferably 0 to 200, for the reason that when a resin composition containing component (A) wherein “a” is more than 1,000 is used as a coating film, the film has an insufficient strength. The subscript b is a positive number of 100 to 10,000, preferably 1,000 to 5,000, for the reason that if b is less than 100, the coating film is less flexible and if b is more than 10,000, the film has low tear strength. The subscript c is a positive number of 1 to 10. If c is more than 10, no slidability effect is exerted.

The subscript d is a positive number of 1 to 1,000, preferably 1 to 200. It is preferred from the aspect of crosslinking that the organopolysiloxane have at least 2, preferably 2 to 4 hydroxy groups at both ends per molecule.

The organopolysiloxane having formula (1) is preferably used in emulsion form. A commercially available compound may be used, or the organopolysiloxane may be synthesized. For synthesis, any well-known emulsion polymerization method is applicable. For example, the organopolysiloxane can be readily synthesized by dispersing and emulsifying a cyclic organosiloxane which may have fluorine, (meth)acryloxy, carboxy, hydroxy or amino group, or α,ω-dihydroxysiloxane oligomer, α,ω-dialkoxysiloxane oligomer or alkoxysilane, and a silane coupling agent having the general formula (2) in water with the aid of an anionic surfactant, optionally adding a catalyst such as acid, and effecting polymerization reaction.

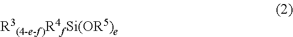

Herein R³ is a monovalent organic group having a polymerizable double bond, specifically an acryloxy or methacryloxy-substituted C₁-C₆ alkyl group, R⁴ is a C₁-C₄ alkyl group, R⁵ is a C₁-C₄ alkyl group, e is 2 or 3, f is 0 or 1, and e+f is 2 or 3.

Examples of the cyclic organosiloxane include hexamethylcyclotrisiloxane (D3), octamethylcyclotetrasiloxane (D4), decamethylcyclopentasiloxane (D5), dodecamethylcyclohexasiloxane (D6), 1,1-diethylhexamethylcyclotetrasiloxane, phenylheptamethylcyclotetrasiloxane, 1,1-diphenylhexamethylcyclotetrasiloxane, 1,3,5,7-tetravinyltetramethylcyclotetrasiloxane, 1,3,5,7-tetramethylcyclotetrasiloxane, 1,3,5,7-tetracyclohexyltetramethylcyclotetrasiloxane, tris(3,3,3-trifluoropropyl)trimethylcyclotrisiloxane, 1,3,5,7-tetra(3-methacryloxypropyl)tetramethylcyclotetrasiloxane, 1,3,5,7-tetra(3-acryloxypropyl)tetramethylcyclotetrasiloxane, 1,3,5,7-tetra(3-carboxypropyl)tetramethylcyclotetrasiloxane, 1,3,5,7-tetra(3-vinyloxypropyl)tetramethylcyclotetrasiloxane, 1,3,5,7-tetra(p-vinylphenyl)tetramethylcyclotetrasiloxane, 1,3,5,7-tetra[3-(p-vinylphenyl)propyl]tetramethylcyclotetrasiloxane, 1,3,5,7-tetra(N-acryloyl-N-methyl-3-aminopropyl)tetramethylcyclotetrasiloxaiie, and 1,3,5,7-tetra(N,N-bis(lauroyl-3-aminopropyl)tetramethylcyclotetrasiloxane. Preferably, octamethylcyclotetrasiloxane or decamethylcyclopentasiloxane is used.

Examples of the silane coupling agent include vinylsilanes such as vinyltrimethoxysilane, vinyltriethoxysilane, vinyltripropoxysilane, vinyltriisopropoxysilane, vinyhmethyldimethoxysilane, and vinylmethyldiethoxysilane; acrylic silanes such as γ-(meth)acryloxypropyltrimethoxysilane, γ-(meth)acryloxypropyltriethoxysilane, γ-(meth)acryloxypropyltripropoxysilaiie, γ-(meth)acryloxypropyltriisopropoxysilane, γ-(meth)acryloxypropyltributoxysilane, γ-(meth)acryloxypropylmethyldimethoxysilane, γ-(meth)acryloxypropyhnethyldiethoxysilane, γ-(meth)acryloxypropylmethyldipropoxysilane, γ-(meth)acryloxypropylmethyldiisopropoxysilane, and γ-(meth)acryloxypropylmethyldibutoxysilane; and mercaptosilanes such as γ-mercaptopropylmethyldimethoxysilane and γ-mercaptopropyltrimethoxysilane. Oligomers obtained from polycondensation of the foregoing are sometimes more preferable because the formation of alcohol is suppressed. As used herein, (meth)acryloxy refers to acryloxy or methacryloxy. The silane coupling agent is preferably used in an amount of from 0.01 to 20 parts by weight, more preferably from 0.01 to 5 parts by weight per 100 parts by weight of the cyclic organosiloxane.

Copolymerization of the silane coupling agent results in an organopolysiloxane containing units (c) in formula (1), so that the effect of grafting vinyl acetate (B-1) is exerted.

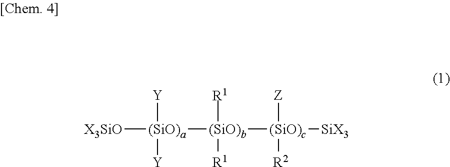

The catalyst used in polymerization may be any of well-known polymerization catalysts. Inter alia, strong acids are preferred. Exemplary are hydrochloric acid, sulfuric acid, dodecylbenzenesulfonic acid, citric acid, lactic acid, and ascorbic acid. Of these, dodecylbenzenesulfonic acid having surface activation ability is preferred.

The amount of the acid catalyst used is preferably from 0.01 to 10 parts by weight, more preferably from 0.2 to 2 parts by weight per 100 parts by weight of the cyclic organosiloxane.

As the surfactant used in polymerization, anionic surfactants are typical, for example, sodium lauryl sulfate, sodium laureth sulfate, N-acylamino acid salts, N-acyl taurine salts, aliphatic soaps, and alkyl phosphates. Those surfactants which are fully soluble in water and free of a polyethylene oxide chain are preferred. Inter alia, N-acylamino acid salts, N-acyl taurine salts, aliphatic soaps, and alkyl phosphates are preferred. Specifically, sodium lauroyl methyl taurine, sodium myristoyl methyl taurine and sodium lauryl sulfate are preferred.

The amount of the anionic surfactant used is preferably from 0.1 to 20 pails by weight, more preferably from 0.5 to 10 parts by weight per 100 parts by weight of the cyclic organosiloxane.

The polymerization temperature is preferably 50 to 75° C., and the polymerization time is preferably at least 10 hours, more preferably at least 15 hours. It is more preferred that the polymerization be followed by aging at 5 to 30° C. for at least 10 hours.

The organopolysiloxane (A) thus obtained should preferably have a weight average molecular weight (Mw) based on viscosity measurement of from 10,000 to 1,000,000, more preferably from 100,000 to 500,000. A Mw of less than 10,000 invites a failure to exert any slidability effect.

The weight average molecular weight (Mw) of an organopolysiloxane based on viscosity measurement can be computed from the specific viscosity ηsp at 25° C. of a toluene solution of the organopolysiloxane having a concentration of 1 g/100 ml.

$$η sp = ( η / η 0 ) - 1$$

Herein η0 is the viscosity of toluene and η is the viscosity of the solution.

$$η sp = [ η ] + {0.3 [ η ]}^{2}$$

$$[ η ] = 2.15 \times {10}^{- 4} {M}^{0.65}$$

Specifically, 20 g of the emulsion is mixed with 20 g of isopropyl alcohol (IPA) to break the emulsion. IPA is discarded and the remaining rubbery organopolysiloxane is dried at 60° C. overnight. Using the dry product, a toluene solution of organopolysiloxane having a concentration of 1 g/100 ml is prepared, which is measured for viscosity at 25° C. by Ubbelohde viscometer. Mw is determined by substituting the viscosity into the above formula. Reference is made to Nakamuda, JCIA, 77, 858 (1956) and Doklady Akad. Nauk. USSR, 89, 65 (1953).

The silicone-vinyl acetate copolymer resin of the invention is obtained by adding a water-soluble polymer (C) during emulsion graft polymerization of vinyl acetate (B-1) to the organopolysiloxane (A-1) thus obtained.

In the graft polymerization, the weight ratio of the organopolysiloxane having formula (1) to vinyl acetate, that is, the weight ratio of organopolysiloxane having formula (1) to vinyl acetate units is from 10:90 to 95:5, preferably from 20:80 to 85:15. If the proportion of polysiloxane component having formula (1) is less than 10, a failure to exert any slidability effect occurs.

Examples of the water-soluble polymer (C) include natural polymers such as protein, starch, gelatin, and casein, modified natural polymers such as dextrin, methyl cellulose, ethyl cellulose, hydroxyethyl cellulose, and carboxymethyl cellulose, and synthetic polymers such as polyvinyl alcohol, polyacrylic acid, sodium polyacrylate, polyvinyl pyrrolidone, polyacrylamide, polyvinylamide, polyamine, and polyethylene oxide based polymers. Preferred are polyvinyl alcohol based polymers having surface activation ability.

The content of water-soluble polymer (C) in the silicone-vinyl acetate copolymer resin is adjusted such that the weight ratio of vinyl acetate units (B) to water-soluble polymer (C) is from 100:5 to 100:50. Accordingly, the amount of water-soluble polymer (C) used during emulsion graft polymerization is preferably adjusted to provide 5 to 50 parts by weight, more preferably 10 to 40 parts by weight of water-soluble polymer (C) as solids per 100 parts by weight of vinyl acetate (B-1). If the amount of component (C) added is less than 5 parts by weight, a failure to exert any solvent resistant effect occurs. If the amount exceeds 50 parts by weight, a failure to exert any slidability effect occurs.

The water-soluble polymer (C) may be admitted at any stage, that is, before, during or after the emulsion graft polymerization of vinyl acetate (B-1) to organopolysiloxane (A-1). One exemplary procedure involves adding water-soluble polymer (C) to organopolysiloxane (A-1), then adding vinyl acetate (B-1), and starting polymerization. Another procedure involves starting polymerization of organopolysiloxane (A-1) with vinyl acetate (B-1), then adding water-soluble polymer (C). In the procedure of adding water-soluble polymer (C) after the start of polymerization, water-soluble polymer (C) is preferably added when the polymerization rate of (A-1) and (B-1) is in the range of from 0.1 to 80%, more preferably from 1 to 60%.

A radical initiator is used during emulsion graft polymerization of vinyl acetate (B-1) to organopolysiloxane (A-1). Exemplary initiators include persulfates such as potassium persulfate and ammonium persulfate, hydrogen persulfate water, t-butyl hydroperoxide, and hydrogen peroxide. If necessary, there may be used a redox system combined with a reducing agent such as acidic sodium sulfite, Rongalit, L-ascorbic acid, tartaric acid, saccharides, and amines. The amount of radical initiator used is preferably from 0.1 to parts by weight, more preferably from 0.5 to 3 parts by weight per 100 parts by weight of vinyl acetate (B-1).

Although the surface activation ability of the surfactant in the organopolysiloxane emulsion and water-soluble polymer (C) is sufficient to induce graft polymerization, an anionic surfactant may be added for stability enhancement. Suitable anionic surfactants include sodium lauryl sulfate, sodium laureth sulfate, N-acylamino acid salts, N-acyl taurine salts, aliphatic soaps, and alkyl phosphates. A nonionic emulsifier may also be added, for example, polyoxyethylene lauryl ether and polyoxyethylene tridecyl ether. When added, the amount of the surfactant used is preferably from 0.1 to 5 parts by weight per 100 parts by weight of vinyl acetate (B-1).

The temperature of graft polymerization of component (B) to component (A) is preferably from 25 to 85° C., more preferably from 75 to 85° C. The polymerization time is preferably from 2 to 8 hours, more preferably from 3 to 6 hours.

Further, a chain transfer agent may be added for adjusting the molecular weight and graft rate of graft polymer. Exemplary are halogenated hydrocarbons such as chloroform and carbon tetrachloride, and mercaptans such as n-dodecylmercaptan, tert-dodecylmercaptan and n-octylmercaptan.

The resin composition comprising the silicone-vinyl acetate copolymer resin thus obtained is a polymer to which vinyl acetate is randomly grafted. The resin composition is in such form that the water-soluble polymer is dispersed around the silicone-vinyl acetate copolymer resin.

Also, in the resin composition comprising the silicone-vinyl acetate copolymer resin, the emulsion preferably has a solid content of from 25 to 40% by weight. The emulsion preferably has a viscosity at 25° C. of from 1 to 500 mPa·s, more preferably from 1 to 200 mPa·s. The viscosity is measured by a rotational viscometer. The average particle size is preferably from 0.1 μm (100 nm) to 0.5 μm (500 nm). The average particle size is measured by a laser diffraction/scattering particle size distribution measuring system.

Of 100% by weight of the emulsion (solids), the total of the amount of the copolymer resin consisting of organopolysiloxane units (A) and vinyl acetate units (B) and the amount of water soluble polymer (C) accounts for preferably at least 70% by weight, more preferably at least 80% by weight, even more preferably at least 90% by weight.

The resin composition comprising the silicone-vinyl acetate copolymer resin may be granulated into powder form by the following method. Exemplary methods include freeze grinding, spray drying and pneumatic conveying drying, with the freeze grinding being preferred from the aspect of productivity. The freeze grinding is performed by the well-known freeze grinding method, that is, by immersing the resin in liquefied nitrogen for freezing, admitting the frozen resin into a freeze grinder, and grinding the resin into powder. Any of well-known freeze grinders may be used. The resulting powder has an average particle size of preferably up to 50 μm, more preferably from 1 to 30 μm since a smaller particle size is better. The particle size of the emulsion and the powder may be measured as accumulative weight average value D50 by a laser diffraction particle size analyzer.

In the resin composition comprising the silicone-vinyl acetate copolymer resin, organic solvents and other resins may be blended, for example, other resins, pigments, fillers, matte agents, antioxidants, UV absorbers, anti-freezing agents, pH regulators, preservatives, defoamers, antibacterial agents, mildew-proof agents, photo-stabilizers, antistatic agents, plasticizers, flame retardants, thickeners, surfactants, and film-formers. Then the resin composition may be used as coating agents for a variety of base materials such as synthetic resins, metals, glass, porcelain, gypsum, paper, wood, lather, lightweight concrete, lightweight aerated concrete, mortar, calcium silicate boards, slates, gypsum boards; adhesives, internal and external paint binders for structures and building materials, paper treating agents, textile treating agents, and cosmetics.

The resin composition comprising the silicone-vinyl acetate copolymer resin, and the dispersion containing the resin composition may be used as a coating agent. In this embodiment, a coating composition is obtained by mixing or dissolving the silicone-vinyl acetate copolymer resin in another component by a well-known mixing method on a propeller agitator, homogenizer, ball mill, or bead mill. The coating composition is applied to one or both surfaces of a substrate of glass or resin by coating or dipping and dried to impart slidability and substrate adhesion.

### EXAMPLES

Examples and Comparative Examples are given below for illustrating the invention although the invention is not limited thereto. The molecular weight is a weight average molecular weight (Mw) based on viscosity measurement as computed from the specific viscosity of a toluene solution of organopolysiloxane having a concentration of 1 g/100 ml.

### Example 1

A 2-L polyethylene beaker was charged with a solution of 500 g of octamethylcyclotetrasiloxane, 2.5 g of γ-methacryloxypropylmethyldimethoxysilane, and 5 g of sodium lauryl sulfate in 45 g of deionized water and a solution of 5 g of dodecylbenzenesulfonic acid in 45 g of deionized water, which were uniformly emulsified by a homomixer. The emulsion was diluted by gradually adding 400 g of water and passed twice through a high-pressure homogenizer under pressure 300 kgf/cm², obtaining a uniform white emulsion. The emulsion was transferred to a 2-L glass flask equipped with a stirrer, thermometer and reflux condenser, where polymerization reaction was carried out at 55° C. for 24 hours. The emulsion was aged at 20° C. for 24 hours and then neutralized at pH 7 with 10% sodium carbonate aqueous solution. The emulsion had a nonvolatile (solids) content of 45% after drying at 105° C. for 3 hours. The organopolysiloxane in the emulsion was a non-flowing soft gel. The silicone composition had the structure having formula (1) with a molecular weight of about 250,000 as calculated from the viscosity of a toluene solution. The structure of the organopolysiloxane obtained from the above polymerization reaction was confirmed by ¹H-NMR (frequency 600 MHz, room temperature, number of transients 128) and ²⁹Si-NMR (frequency 600 MHz, room temperature, number of transients 5,000) using an analyzer JNM-ECA600 (measurement solvent: CDCl₃).

To the silicone composition was added 1,580 g of a 10% polyvinyl alcohol aqueous solution (degree of saponification 98.5 mol %, degree of polymerization 500). While 1,053 g of vinyl acetate was added dropwise over 3 to 5 hours, reaction was carried out at 80° C. using an initiator whereby vinyl acetate was graft copolymerized to the silicone composition. There was obtained a silicone-vinyl acetate copolymer resin emulsion having a nonvolatile content of 30%. It was confirmed by FT-IR ATR spectroscopy (analyzer, IR Affinity-1S by Shimadzu Corp.) and GCMS (analyzer, GCMS-QP2010 Ultra by Shimadzu Corp.) that the resulting resin emulsion contained polyvinyl alcohol.

### Examples 2 to 4

Silicone-vinyl acetate copolymer resin emulsions having a nonvolatile content of 30% were obtained by the same procedure as in Example 1 except that the amounts of components (A) to (C) were changed as shown in Table 1.

### Comparative Example 1

A 2-L polyethylene beaker was charged with a solution of 500 g of octamethylcyclotetrasiloxane, 2.5 g of γ-methacryloxypropylmethyldimethoxysilane, and 5 g of sodium lauryl sulfate in 45 g of deionized water and a solution of 5 g of dodecylbenzenesulfonic acid in 45 g of deionized water, which were uniformly emulsified by a homomixer. The emulsion was diluted by gradually adding 400 g of water and passed twice through a high-pressure homogenizer under pressure 300 kgf/cm obtaining a uniform white emulsion. The emulsion was transferred to a 2-L glass flask equipped with a stirrer, thermometer and reflux condenser, where polymerization reaction was carried out at 55° C. for 24 hours. The emulsion was aged at 20° C. for 24 hours and then neutralized at pH 7 with 10% sodium carbonate aqueous solution. The emulsion had a nonvolatile (solids) content of 45% after drying at 105° C. for 3 hours. The organopolysiloxane in the emulsion was a non-flowing soft gel. The silicone composition had the structure having formula (1) with a molecular weight of about 250,000 as calculated from the viscosity of a toluene solution.

To the silicone composition was added 26 g of polyoxyethylene alkyl ether. While 1,053 g of vinyl acetate was added dropwise over 3 to 5 hours, reaction was carried out at 80° C. using an initiator whereby vinyl acetate was graft copolymerized to the silicone composition. There was obtained a silicone-vinyl acetate copolymer resin emulsion having a nonvolatile content of 30%.

### Comparative Example 2

A 2-L polyethylene beaker was charged with a solution of 500 g of octamethylcyclotetrasiloxane, 46 g of vinylmethyldimethoxysilane, and 5 g of sodium lauryl sulfate in 45 g of deionized water and a solution of 5 g of dodecylbenzenesulfonic acid in 45 g of deionized water, which were uniformly emulsified by a homomixer. The emulsion was diluted by gradually adding 450 g of water and passed twice through a high-pressure homogenizer under pressure 300 kgf/cm², obtaining a uniform white emulsion. The emulsion was transferred to a 2-L glass flask equipped with a stirrer, thermometer and reflux condenser, where polymerization reaction was carried out at 55° C. for 24 hours. The emulsion was aged at 10° C. for 24 hours and then neutralized at pH 7 with 10% sodium carbonate aqueous solution. The emulsion had a nonvolatile (solids) content of 45% after drying at 105° C. for 3 hours. The organopolysiloxane in the emulsion was a non-flowing soft gel. The silicone composition had the structure having formula (1) with a molecular weight of about 400,000 as calculated from the viscosity of a toluene solution.

To the silicone composition was added 23 g of polyoxyethylene alkyl ether. While 1,151 g of vinyl acetate was added dropwise over 3 to 5 hours, reaction was carried out at 80° C. using an initiator whereby vinyl acetate was graft copolymerized to the silicone composition. There was obtained a silicone-vinyl acetate copolymer resin emulsion having a nonvolatile content of 30%.

### Comparative Example 3

A 2-L polyethylene beaker was charged with a solution of 500 g of octamethylcyclotetrasiloxane, 1.1 g of vinylmethyldimethoxysilane, and 5 g of sodium lauryl sulfate in 45 g of deionized water and a solution of 5 g of dodecylbenzenesulfonic acid in 45 g of deionized water, which were uniformly emulsified by a homomixer. The emulsion was diluted by gradually adding 400 g of water and passed twice through a high-pressure homogenizer under pressure 300 kgf/cm², obtaining a uniform white emulsion. The emulsion was transferred to a 2-L glass flask equipped with a stirrer, thermometer and reflux condenser, where polymerization reaction was carried out at 55° C. for 24 hours. The emulsion was aged at 10° C. for 24 hours and then neutralized at pH 7 with 10% sodium carbonate aqueous solution. The emulsion had a nonvolatile (solids) content of 45% after drying at 105° C. for 3 hours. The organopolysiloxane in the emulsion was a non-flowing soft gel. The silicone composition had the structure having formula (1) with a molecular weight of about 400,000 as calculated from the viscosity of a toluene solution.

To the silicone composition was added 21 g of polyoxyethylene alkyl ether. While 1,051 g of vinyl acetate was added dropwise over 3 to 5 hours, reaction was carried out at 80° C. using an initiator whereby vinyl acetate was graft copolymerized to the silicone composition. There was obtained a silicone-vinyl acetate copolymer resin emulsion having a nonvolatile content of 30%.

The emulsions of Examples 1 to 4 and Comparative Examples 1 to 3 were evaluated by the following methods, with the results shown in Table 1.

### <Graft Points>

The number of graft points was computed according to the following formula.

A=(weight of silane coupling agent)/(molecular weight of silane coupling agent)

B=(weight of siloxane)/(calculated molecular weight of organopolysiloxane)

The value of A/B is defined as the number of graft points.

For example, in the case of the silicone-vinyl acetate copolymer resin emulsion in Preparation Example 1 wherein

$$\cdot A = 2.5 / 232 = 0.0108 mol$$

$$\cdot B = ( 500 + 2.5 ) / 250 , 000 = 0.00201 mol$$

The value of A/B is about 5, that is, the number of graft points is 5.

The number of graft points can be adjusted by the amount of silane coupling agent.

### <Method of Measuring Solids Content>

A sample of about 1 g was accurately weighed in a dish of aluminum foil, which was placed in a dryer kept at about 105° C. heated for 1 hour, taken out of the drier, and allowed to cool in a desiccator. The weight of the sample after drying was measured. The evaporation residue was calculated according to the following formula.

$$R = \frac{T - L}{W - L} \times 100 \qquad [ Math . 1 ]$$

R: evaporation residue (%)
W: weight (g) of aluminum dish containing the sample before drying
L: weight (g) of aluminum dish
T: weight (g) of aluminum dish containing the sample after drying
aluminum dish dimensions: diameter 65 mm, height 23 mm

### <Method of Measuring Viscosity>

While a liquid sample was kept at 23±0.5° C., its viscosity was measured by BM viscometer (#1 rotor, 6 rpm).

### <Measurement of Coefficient of Static and Dynamic Friction>

Using a bar coater, each of the emulsion compositions of Examples and Comparative Examples was coated onto a PET film and dried at 105° C. for 3 minutes. A dry coating of about 10 μm thick was formed.

A coefficient of friction was calculated by using HEIDON TYPE-38 (Shinto Scientific Co., Ltd.), bringing a metal indenter of 30 g in vertical contact with the coating, moving it at 3 cm/min, and measuring a frictional force. The preferred ranges of coefficient of static and dynamic friction under the foregoing conditions are a coefficient of static friction of up to 0.3 and a coefficient of dynamic friction of up to 0.20.

### <Water Resistance and Chemical Resistance>

Each of the emulsion compositions of Examples and Comparative Examples was cast into a PP tray and dried at 40° C. for 24 hours. A dry coating of about 1 mm thick was formed. The coating was shaped into a test specimen of 1 inch by 1 inch.

Each of the solvents (water, methanol and DMF), 100 g, was metered into a glass bottle. The specimen whose weight had been measured was placed in the solvent, which was stirred for 1 hour by a stirrer. After 1 hour of stirring and filtration through a 300-mesh screen, the specimen was dried at 40° C. for 24 hours and measured for weight again. An insoluble fraction (%) was calculated from the weight loss.

### <Substrate Adhesion>

Using a bar coater, each of the emulsion compositions of Examples and Comparative Examples was coated onto a PET film and dried at 105° C. for 3 minutes. A dry coating of about 10 mi thick was formed.

After the coating was cut by a cutting knife and rubbed with the finger over 10 reciprocal strokes, the coating was visually observed for adhesion.
◯: no stripping from the substrate
x: stripping from the substrate

### <Scratch Resistance>

Using a bar coater, each of the emulsion compositions of Examples and Comparative Examples was coated onto a PET film and dried at 105° C. for 3 minutes. A dry coating of about 10 μm thick was formed.

The coating on the PET film was examined for scratch resistance by a friction tester (Yasuda Seiki Seisakusho Ltd.) using a cotton cloth-mounted metal contactor under a load of 98 N. In the test of 1,000 cycles, the number of cycles repeated until the coating was damaged was determined by visual observation.

### <Bleed-Out>

Each of the emulsion compositions of Examples and Comparative Examples was cast into a PP tray and dried at 40° C. for 24 hours. A dry coating of about 1 mm thick was formed.

The coating surface was visually observed to see whether silicone bled out with the lapse of time.
◯: no bleed-out observed
Δ: some bleed-out observed
x: noticeable bleed-out observed

TABLE 1

| | | Example | | | | Comparative Example | | |
|---|---|---|---|---|---|---|---|---|
| | | 1 | 2 | 3 | 4 | 1 | 2 | 3 |
| Preparation of | D4 (octamethylcyclotetrasiloxane) | 100 | 100 | 100 | 100 | 100 | 100 | 100 |
| organo- | γ-methacryloxypropylmethyldimethoxysilane | 0.5 | 0.5 | 0.5 | 0.5 | 0.5 | — | — |
| polysiloxane | vinylmethyldimethoxysilane | — | — | — | — | — | 9.2 | 0.2 |
| (A) | Number of graft points | 5 | 5 | 5 | 5 | 5 | 250 | 7 |
| (parts by weight) | | | | | | | | |
| Graft | (A) organopolysiloxane | 30 | 30 | 30 | 70 | 30 | 30 | 30 |
| copolymer resin | (B) vinyl acetate | 70 | 70 | 70 | 30 | 70 | 70 | 70 |
| (weight ratio) | (C) polyvinyl alcohol | 10.5 (15) | 7.0 (10) | 21.0 (30) | 4.5 (15) | — | — | — |
| Test results | Solid content (wt %) | 30 | 30 | 30 | 30 | 30 | 30 | 30 |
| | Viscosity (mPa · s) | 20 | 20 | 40 | 20 | 10 | 10 | 10 |
| | Coefficient of static friction | 0.1 | 0.1 | 0.1 | 0.1 | 0.1 | 0.1 | 0.1 |
| | Coefficient of dynamic friction | 0.09 | 0.07 | 0.10 | 0.07 | 0.07 | 0.10 | 0.01 |
| | Water resistance (%) | 98 | 98 | 95 | 98 | 99 | 99 | 99 |
| | Methanol resistance (%) | 95 | 75 | 95 | 95 | 30 | 0 | 25 |
| | DMF resistance (%) | 95 | 50 | 95 | 95 | 25 | 0 | 15 |
| | Substrate adhesion | ◯ | ◯ | ◯ | ◯ | ◯ | ◯ | ◯ |
| | Scratch resistance (cycles) | 1,000 | 1,000 | 750 | 500 | 400 | 750 | 250 |
| | Bleed-out | ◯ | ◯ | ◯ | ◯ | ◯ | ◯ | ◯ |

* In Table 1, the figure in parentheses of polyvinyl alcohol (C) designates parts by weight of component (C) per 100 parts by weight of vinyl acetate (B).

As shown in Table 1, the emulsion compositions containing the silicone-acrylic copolymer resins of Comparative Examples 1 to 3 were inferior in solvent resistance. In contrast, the silicone-vinyl acetate copolymer resin emulsion compositions of Example 1 form coatings which are excellent in sliding, adhesion, solvent resistance and scratch resistance.

1. A resin composition comprising a copolymer resin consisting of (A) organopolysiloxane units derived from an organopolysiloxane having the general formula (1) and (B) vinyl acetate units, and (C) a water-soluble polymer, wherein the weight ratio of organopolysiloxane units (A) to vinyl acetate units (B), i.e., (A):(B) is from 10:90 to 95:5, and the weight ratio of vinyl acetate units (B) to water-soluble polymer (C) is from 100:5 to 100:50, 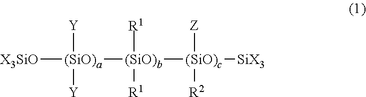
wherein R¹ which may be the same or different is a substituted or unsubstituted C₁-C₂₀ monovalent hydrocarbon group, R² is a mercapto, acryloxy or methacryloxy-substituted C₁-C₆ alkyl group or vinyl group, X which may be the same or different is a substituted or unsubstituted C₁-C₂₀ monovalent hydrocarbon group, C₁-C₂₀ alkoxy group or hydroxy group, Y which may be the same or different is X or —[O—Si(X)₂]_{d}—X, at least two of X and Y are hydroxy, Z is a C₁-C₄ alkyl group, C₁-C₄ alkoxy group or hydroxy group, a is a positive number of 0 to 1,000, b is a positive number of 100 to 10,000, c is a positive number of 1 to 10, and d is a positive number of 1 to 1,000.

2. The resin composition of claim 1 which is in the form of an emulsion having a viscosity at 25° C. of 1 to 500 mPa·s.

3. The resin composition of claim 1 wherein the organopolysiloxane having formula (1) has a weight average molecular weight (Mw) based on viscosity measurement of 10,000 to 1,000,000.

4. The resin composition of claim 1 wherein the organopolysiloxane having formula (1) is a polymer of a cyclic organosiloxane, α,ω-dihydroxysiloxane oligomer, α,ω-dialkoxysiloxane oligomer or alkoxysilane with a silane coupling agent having the general formula (2): 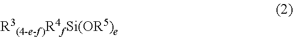
wherein R³ is a mercapto, acryloxy or methacryloxy-substituted C₁-C₆ alkyl group, R⁴ is a C₁-C₄ alkyl group, R⁵ is a C₁-C₄ alkyl group, e is 2 or 3, f is 0 or 1, and e+f is 2 or 3.

5. The resin composition of claim 1 which is used as a product selected from coating agents, textile treating agents, adhesives, paints and cosmetics.

6. A dispersion comprising the resin composition of claim 1.

7. A method for preparing a resin composition comprising the steps of emulsion polymerizing (A-1) an organopolysiloxane having the general formula (1) with (B-1) vinyl acetate in a weight ratio (A-1):(B-1) of from 10:90 to 95:5, and admitting (C) a water-soluble polymer during the emulsion polymerization, in an amount of 5 to 50 parts by weight of water-soluble polymer (C) as solids per 100 parts by weight of vinyl acetate (B-1), thereby forming a resin emulsion, 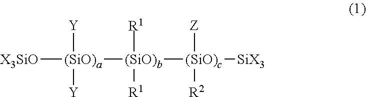
wherein R¹ which may be the same or different is a substituted or unsubstituted C₁-C₂₀ monovalent hydrocarbon group, R² is a mercapto, acryloxy or methacryloxy-substituted C₁-C₆ alkyl group or vinyl group, X which may be the same or different is a substituted or unsubstituted C₁-C₂₀ monovalent hydrocarbon group, C₁-C₂₀ alkoxy group or hydroxy group, Y which may be the same or different is X or —[O—Si(X)₂]_{d}—X, at least two of X and Y are hydroxy, Z is a C₁-C₄ alkyl group, C₁-C₄ alkoxy group or hydroxy group, a is a positive number of 0 to 1,000, b is a positive number of 100 to 10,000, c is a positive number of 1 to 10, and d is a positive number of 1 to 1,000.
